(19) United States
(12) Patent Application Publication
(10) Pub. No.: US 2026/0067620 A1
(43) Pub. Date: Mar. 5, 2026

(54) METHOD FOR OPERATING A SPEAKER

(71) Applicant: paragon GmbH & Co. KGaA, Delbrück (DE)

(72) Inventors: Johannes BOEHM, Göttingen (DE); Dirk OLSZEWSKI, Paderborn (DE); Jonas STUECKEMANN, Bielefeld (DE)

(21) Appl. No.: 19/313,466

(22) Filed: Aug. 28, 2025

(30) Foreign Application Priority Data
Sep. 2, 2024 (LU) 508163

(51) Int. Cl. H04R 3/04; H04R 29/00

(52) U.S. Cl. CPC H04R 3/04; H04R 29/001; H04R 2499/11

(57) ABSTRACT

A method for operating a speaker, in particular a dynamic speaker, in which a reference signal for producing a pilot tone and a useful signal for producing sound by the speaker are processed. The reference signal is generated depending on a property of the useful signal. Advantageously, the reference signal is generated depending on an electrical property, preferably a voltage, a current, and/or a power, of the useful signal.

### CROSS-REFERENCE TO RELATED APPLICATION(S)

This application claims the benefit of LU Application No. 508163, filed Sep. 2, 2024, in which a reference signal for producing a pilot tone and a useful signal for producing sound by the speaker are processed.

### TECHNICAL FIELD

This disclosure relates generally to a method for operating a speaker, in particular a dynamic speaker, in which a reference signal for producing a pilot tone and a useful signal for producing sound by the speaker are processed.

### BACKGROUND

It is known from prior art for a reference signal to be applied in addition to the useful signal in order to linearize driving parameters for dynamic loudspeakers and to measure the current picked up at the same time by a voice coil of the speaker. The reference signal and a result of the measurement of the current picked up are fed to a mathematical model of the speaker and further processed for operating the speaker.

### SUMMARY

The object of the invention is to improve the reproduction of the useful signal by the speaker.

According to the invention, this object is attained by generating the reference signal depending on a property of the useful signal.

If there is a constructive superposition of the pilot tone with the sound generated by the useful signal, the resulting deflections of diaphragms of the speaker set in motion by the two signals are also added together. This leads to a reduction in the diaphragm deflection that can be used for outputting the useful signal and thus counteracts the objective of expanding the usable range of diaphragm deflection by linearization. The inventors have recognized that the useful signal itself can take over the function of the reference signal and can thus also be used as a reference signal.

By linking the reference signal to a property of the useful signal, it becomes possible to adapt the reference signal to the useful signal. In particular, the reference signal and thus the pilot tone can be reduced if the useful signal itself can take over the function of the reference signal. If this happens, the speaker can be used to a greater extent or even completely for reproducing the useful signal. In particular, the deflection of its diaphragm can be used entirely to generate the sound to be reproduced by the useful signal and is no longer needed for reproducing the pilot tone. In addition, the occurrence of intermodulation effects, which can interfere with the sound, as a result of the superposition of the pilot tone with the sound to be output is avoided or even eliminated.

In one embodiment of the invention, the reference signal is generated depending on an electrical property, preferably a voltage, a current, a power, and/or a level, of the useful signal.

In one embodiment of the invention, the reference signal is generated in such a manner that a signal size, preferably a signal amplitude, of the reference signal is dependent on the useful-signal size, preferably the useful-signal amplitude.

It is advantageous for the reference signal to be generated with a maximum pilot-tone amplitude intended for the speaker if the useful-signal amplitude is less than a lower useful-signal amplitude threshold value.

Preferably, the reference signal is generated with a minimum pilot-tone amplitude if the useful-signal amplitude is greater than an upper useful-signal amplitude threshold value. The minimum pilot-tone amplitude may be 0.

In a particularly preferred embodiment of the invention, the reference signal is generated with a variable amplitude that depends on the size of the useful-signal amplitude, preferably if the useful-signal amplitude is greater than the lower useful-signal amplitude threshold value and the useful-signal amplitude is less than the upper useful-signal amplitude threshold value.

Conveniently, the size of the amplitude of the reference signal with the variable amplitude is a function of the useful-signal amplitude.

In an embodiment of the invention, a function of the useful-signal amplitude is and/or comprises an assessment of the useful signal (e.g., by a low-pass filter), a squaring of the useful signal, a calculation of the expected value of the preferably squared and/or filtered useful signal, a comparison of the expected value to threshold values of a switch, a determination of factors from switch with values between [0, 1], a smoothing of said values with a long time constant, and/or a multiplication of the smoothed values by the pilot tone.

Advantageously, the reference signal is selected in such a manner that the pilot tone lies in a frequency spectrum that is inaudible to the human ear. Preferably, a sinusoidal signal is used at a frequency that is significantly lower than the resonance frequency of the speaker.

As mentioned at the beginning, the reference signal and a result of the measurement of the picked-up current are advantageously fed to a mathematical model of the speaker and further processed for operating the speaker. In an embodiment of the invention, values deviating from the output of the model are compensated for linearization.

In one embodiment of the invention, the driving parameters for the speaker are linearized, preferably after the reference signal has been generated.

Advantageously, the method is used for generating operating parameters for the speaker, in particular parameters for driving at least one diaphragm of the speaker, preferably in conjunction with linearization of the driving parameters.

Furthermore, the invention relates to a computer program comprising commands which, when the program is executed by a computer, cause the computer to execute the method described above.

Advantageously, the computer program is a computer program stored on a digital signal processor, a data storage medium, preferably RAM, ROM, CD or the like, or a device, in particular a personal computer, a device with an embedded processor, preferably a digital signal processor, a computer embedded in a device, or a smartphone, or a signal sequence representing data that is suitable for transmission via a computer network, in particular the internet.

The device may be an amplifier or a speaker, or the device may comprise an amplifier or a speaker.

Furthermore, the invention relates to a data carrier signal that transmits the computer program.

Furthermore, the invention relates to a digital signal processor on which the computer program is stored, an audio amplifier comprising a digital signal processor on which the computer program is stored, and/or a sound system comprising an audio amplifier, the audio amplifier comprising a digital signal processor on which the computer program is stored, and a speaker connected to the audio amplifier.

In an embodiment of the invention, the invention relates to a motor vehicle, in particular an automobile, which is provided with a sound system.

### BRIEF DESCRIPTION OF DRAWINGS

The invention is explained in more detail below with reference to an embodiment and the accompanying drawings relating to the embodiment.

FIG. 1 schematically shows a method according to the prior art;

FIG. 2 schematically shows a method according to the invention;

FIG. 3 shows a detail of the method according to FIG. 2;

FIG. 4 shows details of the method according to FIG. 3; and

FIG. 5 shows examples relating to the implementation of the method.

### DETAILED DESCRIPTION

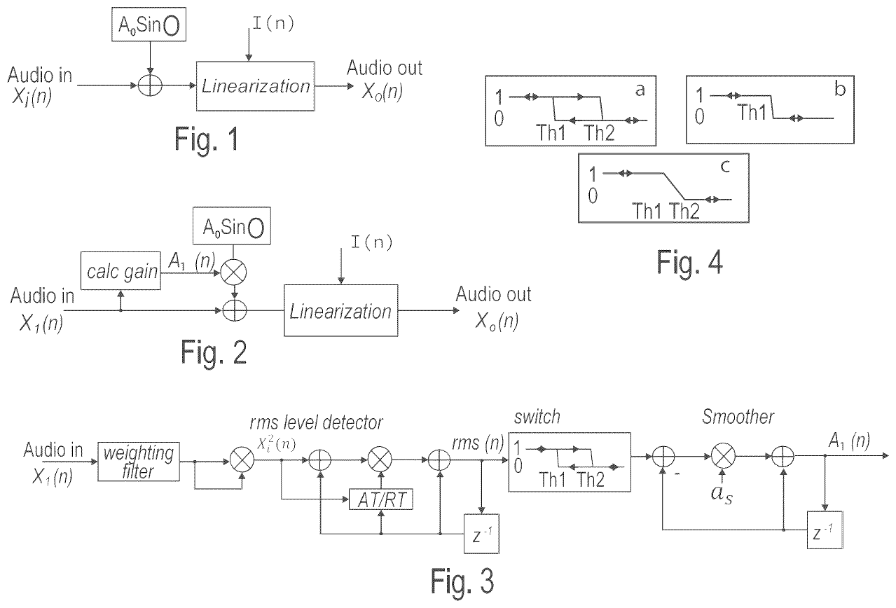

FIG. 1 schematically shows how a reference signal A0 Sin(Φ(n)) for producing a pilot tone is usually added to a useful signal Audio_in xi(n) in order to enable the adjustment of speaker driving parameters for linearization independently of the useful signal. In particular when reproducing a low-frequency useful signal with a large amplitude, this can lead to audible intermodulation effects and limit the range of deflection of a diaphragm of the speaker that can be used for reproducing the useful signal.

FIG. 2 shows an example of the invention with amplitude-dependent pilot tone use. A low-frequency sine signal A0 Sin(Φ(n)) with a variable amplitude is superposed on the useful signal Audio_in xi(n) as a reference signal. The amplitude depends on the useful signal, in particular on its electrical properties, such as voltage, current or power, and/or their levels. It is reduced if the useful signal is so strong that the reference signal is not necessary or not necessary to the full extent for adjusting speaker driving parameters for linearization. Now the range of diaphragm deflection extended by the linearization is fully available for use by the useful signal. As explained in more detail below with reference to FIG. 3, the reduction can depend on an amplitude level of the input signal and be calculated as a function thereof. For example, such a function can be and/or comprise a function of the useful-signal amplitude, an assessment of the useful signal (e.g., by a low-pass filter), a squaring of the useful signal, a calculation of the expected value of the preferably squared and/or filtered useful signal, a comparison of the expected value to threshold values of a switch, a determination of factors from switch with values between [0, 1], a smoothing of said values with a long time constant, and/or a multiplication of the smoothed values by the pilot tone.

Furthermore, a lower threshold value for the useful-signal amplitude may be provided. If the amplitude of the useful signal is below the threshold value, the pilot tone is output with a maximum amplitude intended for the pilot tone, which is required for adjusting speaker driving parameters for linearization.

An upper threshold value for the useful-signal amplitude may be provided in order to form a useful-signal amplitude range in which the reference signal is not required and only the useful signal is further used and linearized. After linearization, an output signal Audio_out xo(n) is output to the speaker.

FIG. 3 shows schematically how the signals can be processed under “calc gain” according to FIG. 2. The useful signal Audio_in xi(n) is filtered by a low-pass filter. An average power or intensity of the filtered signal is determined over time by an RMS level detector, which uses the values (AT) and (RT) as factors of a filter for the rising or falling edge of the squared signal, respectively. When an RMS threshold value is exceeded, an assessment factor of 1 is reduced by a switch. FIG. 4 shows, as examples, a hysteresis switch (a) with two threshold values Th1 and Th2. Alternatively, a hard switch (b) with only one threshold value or a switch with a smoothed transition between TH1 and Th2 can be used, shown here as switch (c).

A smoother smooths the signal output by the switch to avoid abrupt transitions. In the example at hand, exponential smoothing is used, the phase of the sine generator being additionally set to zero when A1(n) drops below a threshold value in order to enable a softer fade-in of the sine signal for quiet audio signals.

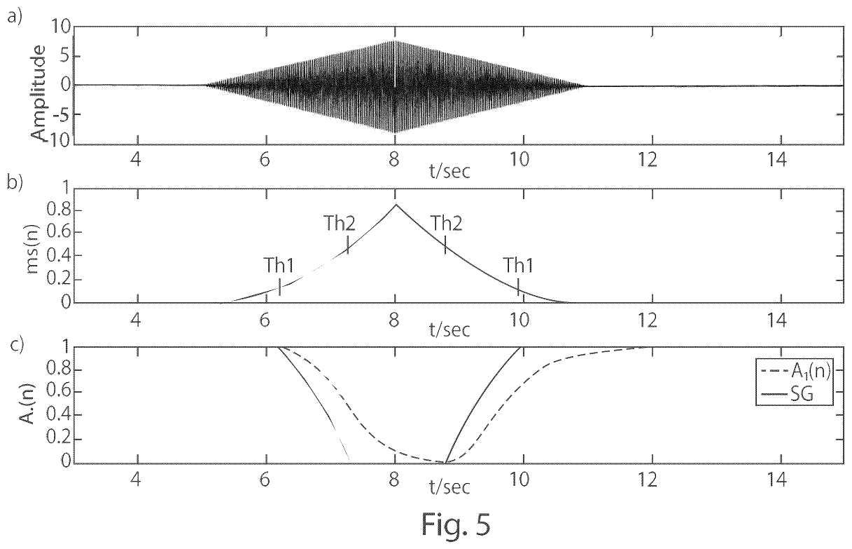

FIG. 5 shows an example for switch c) according to FIG. 4, with a) an amplitude curve of the useful signal Audio_in xi(n) and b) an average power or intensity of the filtered signal. In FIG. 5 c), the solid line represents the output signal variable SG prior to smoothing in the smoother, and the dashed line represents the smoothed output function A1(n).

As can be seen from the graphs, a lower threshold value Th1 of the power/intensity is reached after a period of time shortly after 6 seconds (sec), and the maximum signal size SG output is reduced to 0 shortly after 7 seconds (sec) after reaching the upper threshold value Th2. After the power/intensity has fallen below the upper threshold value Th2 again, the output signal variable SG is gradually increased until it is output at its maximum again when the lower threshold value Th1 is reached. The graph shows how the smoothed output function A1(n) lags behind the output signal size SG.

1. A method for operating a dynamic speaker, in which a reference signal for producing a pilot tone and a useful signal for producing sound by the speaker are processed, wherein the reference signal is generated depending on a property of the useful signal.

2. A method for operating a dynamic speaker, in which a reference signal for producing a pilot tone and a useful signal for producing sound by the speaker are processed, in which driving parameters for being applied to the speaker are generated, wherein the pilot tone is used for linearization.

3. The method according to claim 1, wherein the reference signal is generated depending on an electrical property, which is a voltage, a current, a power, and/or a level, of the useful signal.

4. The method according to claim 1, wherein a signal amplitude of the reference signal is dependent on the useful-signal size, which is the useful-signal amplitude.

5. The method according to claim 4, wherein the reference signal is generated with a maximum pilot-tone amplitude intended for the speaker if the useful-signal amplitude is less than a lower useful-signal amplitude threshold value.

6. The method according to claim 3, wherein the reference signal is generated with a minimum pilot-tone amplitude if the useful-signal amplitude is greater than an upper useful-signal amplitude threshold value.

7. The method according to claim 6, wherein the minimum pilot-tone amplitude is 0.

8. The method according to claim 3, wherein the reference signal is generated with a variable amplitude that depends on the size of the useful-signal amplitude, when the useful-signal amplitude is greater than the lower useful-signal amplitude threshold value and the useful-signal amplitude is less than the upper useful-signal amplitude threshold value.

9. The method according to claim 3, wherein the size of the amplitude of the reference signal with the variable amplitude is a function of the useful-signal amplitude.

10. The method according to claim 1, wherein a function of the useful-signal amplitude comprises an assessment of the useful signal by a low-pass filter, a squaring of the useful signal, a calculation of the expected value of the squared and/or filtered signal, a comparison of the expected value to threshold values of a switch, a determination of factors from switch with values between [0, 1], a smoothing of said values with a long time constant, and/or a multiplication of the smoothed values by the pilot tone.

11. The method according to claim 1, wherein the method is used for generating speaker driving parameters, which is a driving signal, which is applied to the speaker.

12. The method according to claim 11, wherein speaker driving parameters are linearized after the reference signal has been generated.

13. A computer program comprising commands which, when the program is executed by a computer, cause the computer to execute the method according to claim 1.

14. The computer program according to claim 13, wherein the computer program is a computer program stored on a digital signal processor, a data storage medium, preferably RAM, ROM, CD or the like, or a device, which is a personal computer, a device with an embedded digital signal processor, a computer embedded in a device, or a smart phone, or a signal sequence representing data that is suitable for transmission via a computer network.

15. The computer program according to claim 13, wherein the device is an amplifier or a speaker or that the device comprises an amplifier or a speaker.

16. A data carrier signal transmitting the computer program according to claim 13.

17. A digital signal processor on which the computer program according to claim 13 is stored.

18. An audio amplifier comprising a digital signal processor on which the computer program according to claim 13 is stored.

19. A sound system comprising an audio amplifier, the audio amplifier comprising a digital signal processor on which the computer program according to claim 13 is stored, and at least one speaker connected to the audio amplifier.

20. An automobile, provided with a sound system according to claim 19.
